(19) United States
(12) Patent Application Publication
(10) Pub. No.: US 2007/0142573 A1
(43) Pub. Date: Jun. 21, 2007

(54) Epoxy/silicone hybrid resin composition and cured part

(75) Inventor: Kinya Kodama, Annaka-shi (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/640,181

(22) Filed: Dec. 18, 2006

(30) Foreign Application Priority Data
Dec. 19, 2005 (JP) 2005-364415

(51) Int. Cl. C08L 83/04; C08L 63/00; B32B 27/38

(52) U.S. Cl. 525/476; 525/523

(57) ABSTRACT

In an epoxy/silicone hybrid resin composition comprising (A) an organosilicon compound having at least one silanol group, (B) an epoxy resin free of a phenylene ether skeleton, and (C) an aluminum base curing catalyst, at least one of components (A) and (B) is solid at normal temperature, and the composition is solid at normal temperature. The composition is effectively cast moldable and the cured composition has improved heat resistance and light resistance.

### CROSS-REFERENCE TO RELATED APPLICATION

This non-provisional application claims priority under 35 U.S.C. §119(a) on Patent Application No. 2005-364415 filed in Japan on Dec. 19, 2005, the entire contents of which are hereby incorporated by reference.

### TECHNICAL FIELD

This invention relates to epoxy/silicone hybrid resin compositions which are suited for cast molding and improved in heat resistance and light resistance over epoxy resins, and cured parts thereof.

### BACKGROUND ART

As cast molding compounds, resins which are solid at normal temperature have been used because of ease of working. Among others, epoxy resins having excellent electrical properties, light transmission, humidity resistance, and heat resistance are often used as encapsulating resins for optical and other semiconductor members.

JP-A 2005-158766 corresponding to US 2005/0129957 of the inventors discloses an epoxy/silicone hybrid resin composition which is free of surface tack, has good adhesion, and has improved heat resistance and light resistance over epoxy resins, and a light-emitting semiconductor device encapsulated therewith and having a high emission efficacy.

However, there has been disclosed no appropriate form of epoxy/silicone hybrid resin composition which is suitably solid for the cast molding purpose.

### DISCLOSURE OF THE INVENTION

It would be desirable to improve the working efficiency during cast molding of epoxy/silicone hybrid resin compositions which are typically low viscosity or viscous liquids at normal temperature. An object of the invention is to provide an epoxy/silicone hybrid resin composition which is solid at normal temperature, and a cured part thereof having improved heat resistance and light resistance.

With regard to an epoxy/silicone hybrid resin composition comprising (A) an organosilicon compound having at least one silicon-bonded hydroxyl group per molecule, (B) an epoxy resin free of a phenylene ether skeleton, and (C) an aluminum base curing catalyst, the inventor has found that if at least one of components (A) and (B) is solid at normal temperature, the composition becomes a tack-free solid at normal temperature, especially powder, suitable for cast molding processes like transfer molding and that cured parts of the composition have improved heat resistance and light resistance.

The inventor has also found that if in a similar epoxy/silicone hybrid resin composition wherein component (A) is (A′) an organosilicon compound having at least one group containing a multiple bond capable of participating in hydrosilylation reaction and at least one silicon-bonded hydroxyl group per molecule, (D) an organohydrogenpolysiloxane and (E) a platinum group metal-based catalyst are included in addition to (A′), (B) and (C), and at least one of components (A′), (B) and (D) is solid at normal temperature, or if in a similar epoxy/silicone hybrid resin composition wherein component (A) is (AD) an organosilicon compound having at least one group containing a multiple bond capable of participating in hydrosilylation reaction, at least one silicon-bonded hydrogen atom, and at least one silicon-bonded hydroxyl group per molecule, (E) a platinum group metal-based catalyst is included in addition to (AD), (B) and (C), and at least one of components (AD) and (B) is solid at normal temperature, then the composition becomes solid at normal temperature suitable for cast molding; and that utilizing curing reaction by hydrosilylation in combination with curing reaction of epoxy resin, the epoxy/silicone hybrid resin composition formulated as above cures into parts having excellent heat resistance and light resistance.

A first embodiment of the invention is an epoxy/silicone hybrid resin composition comprising as essential components (A) an organosilicon compound having at least one silicon-bonded hydroxyl group per molecule, (B) an epoxy resin free of a phenylene ether skeleton, and (C) an aluminum base curing catalyst, at least one of components (A) and (B) being solid at normal temperature, and the composition being solid at normal temperature.

A second embodiment of the invention is an epoxy/silicone hybrid resin composition comprising as essential components (A′) an organosilicon compound having at least one group containing a multiple bond capable of participating in hydrosilylation reaction and at least one silicon-bonded hydroxyl group per molecule, (B) an epoxy resin free of a phenylene ether skeleton, (C) an aluminum base curing catalyst, (D) an organohydrogenpolysiloxane, and (E) a platinum group metal-based catalyst, at least one of components (A′), (B) and (D) being solid at normal temperature, and the composition being solid at normal temperature.

A third embodiment of the invention is an epoxy/silicone hybrid resin composition comprising as essential components (AD) an organosilicon compound having at least one group containing a multiple bond capable of participating in hydrosilylation reaction, at least one silicon-bonded hydrogen atom, and at least one silicon-bonded hydroxyl group per molecule, (B) an epoxy resin free of a phenylene ether skeleton, (C) an aluminum base curing catalyst, and (E) a platinum group metal-based catalyst, at least one of components (AD) and (B) being solid at normal temperature, and the composition being solid at normal temperature.

Also contemplated herein is a cured part obtained by cast molding the epoxy/silicone hybrid resin composition of any one of the foregoing embodiments.

### BENEFITS OF THE INVENTION

Since the epoxy/silicone hybrid resin composition of the invention is solid at normal temperature, the working efficiency of the composition during cast molding is improved. Cured parts of the composition have improved heat resistance and light resistance over prior art epoxy resins. The invention is of great interest in the industry.

### DESCRIPTION OF THE PREFERRED EMBODIMENT

The terms “a” and “an” herein do not denote a limitation of quantity, but rather denote the presence of at least one of the referenced item.

The term “normal temperature” used herein is equal to 25° C.

One embodiment of the invention is an epoxy/silicone hybrid resin composition comprising as essential components (A) an organosilicon compound having at least one silicon-bonded hydroxyl group per molecule, (B) an epoxy resin free of a phenylene ether skeleton, and (C) an aluminum base curing catalyst. At least one of components (A) and (B) is solid at normal temperature, and the composition is solid at normal temperature.

In a preferred embodiment, component (A) is (A′) an organosilicon compound having at least one group containing a multiple bond capable of participating in hydrosilylation reaction and at least one silicon-bonded hydroxyl group per molecule, and the epoxy/silicone hybrid resin composition comprises as essential components (D) an organohydrogenpolysiloxane and (E) a platinum group metal-based catalyst in addition to components (A′), (B) and (C). At least one of components (A′), (B) and (D) is solid at normal temperature, and the composition is solid at normal temperature.

In another preferred embodiment, component (A) is (AD) an organosilicon compound having at least one group containing a multiple bond capable of participating in hydrosilylation reaction, at least one silicon-bonded hydrogen atom, and at least one silicon-bonded hydroxyl group per molecule, and the epoxy/silicone hybrid resin composition comprises as essential components (E) a platinum group metal-based catalyst in addition to components (AD), (B) and (C). At least one of components (AD) and (B) is solid at normal temperature, and the composition is solid at normal temperature.

Component A

Component (A) is an organosilicon compound having at least one silicon-bonded hydroxyl group per molecule, and preferably (A′) an organosilicon compound having at least one group containing a multiple bond capable of participating in hydrosilylation reaction and at least one silicon-bonded hydroxyl group per molecule.

Suitable organosilicon compounds include organo(poly)siloxanes, organosilalkylenes, and organosilarylenes. Inter alia, organo(poly)siloxanes which can be used herein are those of the average compositional formula (1):
R¹ₐR²_{b}(HO)_{c}(R³O)_{d}SiO_{(4-a-b-c-d)/2} (1)
wherein R¹ is each independently a substituted or unsubstituted monovalent hydrocarbon group having aliphatic unsaturation, R² is each independently a substituted or unsubstituted monovalent hydrocarbon group free of aliphatic unsaturation, R³ is each independently a substituted or unsubstituted monovalent hydrocarbon group free of aliphatic unsaturation, a, b and d are 0 or positive numbers, c is a positive number, and a+b+c+d<4. In the case of component (A′), a>0.

For each of R¹, R², and R³, those hydrocarbon groups of 1 to 10 carbon atoms, and especially 1 to 6 carbon atoms are preferred. Specifically, typical examples of R¹ include alkenyl groups such as vinyl, allyl, propenyl, isopropenyl, and butenyl, acryloxy and methacryloxy groups. Typical examples of R² include alkyl groups such as methyl, ethyl, propyl, butyl, and cyclohexyl, aryl groups such as phenyl and tolyl, aralkyl groups such as benzyl, and oxirane ring-containing organic groups. Typical examples of R³ include alkyl groups such as methyl, ethyl, propyl, and butyl, and aryl groups such as phenyl.

In the event component (A) or (A′) is an organopolysiloxane, it is preferred that a, b, c, and d in formula (1) be 0≦a≦0.5, especially 0≦a≦0.25 (provided a>0 for component (A′)), 0<b≦2.4, especially 0.5≦b≦2, 0<c≦0.5, especially 0.01≦c≦0.2, 0≦d≦0.5, especially 0≦d≦0.2, and 0.8≦a+b+c+d≦3, especially 1≦a+b+c+d≦2.5.

In the other preferred embodiment, component (A) is (AD) an organosilicon compound having at least one group containing a multiple bond capable of participating in hydrosilylation reaction, at least one silicon-bonded hydrogen atom, and at least one silicon-bonded hydroxyl group per molecule. Component (AD) cures in such a way that silicon-bonded hydrogen atoms (SiH groups) in its molecule undergo addition reaction or hydrosilylation with groups having a multiple bond capable of participating in hydrosilylation reaction, for example, aliphatically unsaturated monovalent hydrocarbon groups such as vinyl groups, in another molecule.

Suitable organosilicon compounds (AD) include organo(poly)siloxanes, organosilalkylenes, and organosilarylenes. Inter alia, organo(poly)siloxanes which can be used herein are those of the average compositional formula (2):
HₑR¹_{f}R²_{g}(HO)ₕ(R³O)ⱼSio_{(4-e-f-g-h-j)/2} (2)
wherein R¹ is each independently a substituted or unsubstituted monovalent hydrocarbon group having aliphatic unsaturation, R² is each independently a substituted or unsubstituted monovalent hydrocarbon group free of aliphatic unsaturation, R³ is each independently a substituted or unsubstituted monovalent hydrocarbon group free of aliphatic unsaturation, e, f and h are positive numbers, g and j are 0 or positive numbers, and e+f+g+h+j<4. Examples of R¹, R², and R³ are as illustrated above in conjunction with formula (1).

In the event component (AD) is an organopolysiloxane, it is preferred that e, f, g, h, and j in formula (2) be 0≦e≦5 0.5, especially 0≦e 0.25, 0<f≦0.5, especially 0<f≦0.25, 0<g≦2.4, especially 0.5≦g≦2, 0<h≦0.5, especially 0.01<h≦0.2, 0≦j≦0.5, especially 0≦j≦0.2, and 0.8≦e+f+g+h+j≦3, especially 1≦e+f+g+h+j≦2.5.

The organo(poly)siloxanes containing a silicon-bonded hydroxyl group (i.e., silanol group) can be prepared by (co)hydrolysis or partial hydrolysis of hydrolyzable silanes.

Examples of organopolysiloxanes containing a silicon-bonded hydroxyl group (i.e., silanol group) include those containing siloxane units selected from (CH₃)₂(OH)SiO_{1/2}, (CH₃)₂SiO, CH₃(C₆H₅)(OH)SiO_{1/2}, CH₃SiO_{3/2}, (C₆H₅) SiO_{3/2}, CH₃(C₆H₅)SiO, C₃H₇(CH₃)SiO, (CH₂═CH)(C₆H₅)(OH)SiO_{1/2}, C₆H₅(CH₂═CH)(CH₃)SiO_{1/2},(CH₂═CH)(CH₃)SiO,(CH₂═CH)(C₆H₅)SiO C₆H₅(OH)SiO, (CH₃)₂SiO, (C₆H₅)₂SiO, C₆H₅(CH₃)₂SiO_{1/2}. They may further contain a minor proportion of SiO₂ units. Organopolysiloxanes of this type can be prepared by hydrolyzing an organochlorosilane corresponding to a particular siloxane unit, and condensing hydroxyl groups while leaving a necessary amount of hydroxyl groups.

The preferred component (A) or (A′) or (AD) is an organopolysiloxane of branched or three-dimensional network structure containing trifunctional siloxane units or tetrafunctional siloxane units (SiO₂) in the molecule.

As indicated above, organopolysiloxanes containing silicon-bonded hydroxyl groups range from liquid to solid. The organopolysiloxanes preferably have a silicon-bonded hydroxyl group content of 0.5 to 15% by weight, more preferably 1.5 to 10% by weight. Organopolysiloxanes with a hydroxyl content of less than 0.5% by weight may be less reactive with epoxy groups whereas some organopolysiloxanes with a hydroxyl content of more than 15% by weight cannot be prepared in a consistent manner.

Besides the foregoing organo(poly)siloxanes, there may be used organosilalkylenes and organosilarylenes, and silanol-containing organo(poly)siloxanes having silethylene or silphenylene linkage.

Preferably the organosilicon compound as component (A) comprises an organopolysiloxane. Of the organosilicon compounds as component (A), preferred is (A′) or (AD) an organosilicon compound having a group containing a multiple bond capable of participating in hydrosilylation reaction, for example, an aliphatically unsaturated hydrocarbon group such as alkenyl. When compound (A′) is used as component (A), the inclusion of components (D) and (E) is essential to the composition. When compound (AD) is used, the inclusion of component (E) is essential.

Component B

Component (B) is an epoxy resin which is free of a phenylene ether skeleton, for example, a phenylenoxy group derived from a bisphenol (e.g., bisphenol A or bisphenol F) or biphenyl diol used as a raw material for the epoxy resin. Those epoxy resins which are solid or liquid with a viscosity of at least 100 Pa·s at normal temperature are preferred, though depending on a proportion of the epoxy resin in the entire organic resins. Types of epoxy resin include oligomers and polymers of hydrogenated bisphenol F epoxy resins and hydrogenated bisphenol A epoxy resins, and hydrogenated biphenyl epoxy resins featuring heat resistance and light resistance, and alicyclic epoxy resins, but are not limited thereto as long as epoxy resins are free of phenyl ether skeleton.

The epoxy resin (B) preferably constitutes 5 to 90% by weight based on the entire organic resins (i.e., the total of components (A) and (B), or components (A), (B) and (D)). If this proportion is less than 5 wt %, the epoxy addition effect may be short, resulting in a cured part with insufficient strength. If the proportion is more than 90 wt %, which means a preponderance of epoxy resin, the results of discoloration in heat and light tests have no significant difference from neat epoxy resins. The more preferred proportion is 20 to 80% by weight.

Component C

Component (C) is an aluminum base curing catalyst for promoting polymerization between silanol and epoxy groups. Suitable catalysts may be either organic or inorganic aluminum compounds including aluminum trihydroxide, aluminum alcoholates, aluminum acylates, aluminum acylate salts, aluminosiloxy compounds, and aluminum chelates. The aluminum catalyst may be used in a catalytic amount, specifically in an amount of about 0.05 to 10% by weight, more preferably about 0.3 to 5% by weight based on the weight of components (A), (B) and (C) combined, or the weight of components (A′), (B), (C), (D) and (E) combined, or the weight of components (AD), (B), (C) and (E) combined. Less than 0.05 wt % of the aluminum catalyst may fail to provide a sufficient curing rate whereas more than 10 wt % may induce too fast cure, failing to manufacture a desired light-emitting semiconductor device.

Component D

Component (D) is an organohydrogenpolysiloxane which serves as a crosslinking agent for forming a cured product through addition reaction or hydrosilylation of SiH groups in component (D) with groups containing a multiple bond capable of participating in hydrosilylation reaction in component (A′), specifically aliphatically unsaturated monovalent hydrocarbon groups such as vinyl groups. In the embodiment using component (AD), it is possible to add component (D) if necessary or desirable. In this case, SiH groups in component (D) undergo addition reaction or hydrosilylation with groups containing a multiple bond capable of participating in hydrosilylation reaction in component (AD), specifically aliphatically unsaturated monovalent hydrocarbon groups such as vinyl groups, providing supplementary curing reaction.

Preferred is an organohydrogenpolysiloxane represented by the average compositional formula (3):
HₖR⁴ₘ(HO)ₙ(R⁵O)ₚSiO_{(4-k-m-n-p)/2} (3)
wherein R⁴ is each independently a substituted or unsubstituted monovalent hydrocarbon group free of aliphatic unsaturation, R⁵ is each independently a substituted or unsubstituted monovalent hydrocarbon group free of aliphatic unsaturation, k, m, n and p are numbers satisfying k>0, m>0, n≧0, p≧0, and k+m+n+p<4, and having at least two, more preferably at least three silicon-bonded hydrogen atoms (i.e., SiH groups) per molecule.

In formula (3), R⁴ is preferably a monovalent hydrocarbon group having 1 to 10 carbon atoms, especially 1 to 7 carbon atoms, for example, lower alkyl groups such as methyl, aryl groups such as phenyl, and those exemplified above for R² in formula (1). R⁵ is preferably a monovalent hydrocarbon group having 1 to 10 carbon atoms, especially 1 to 6 carbon atoms, examples of which are as illustrated above for R³ in formula (1). The subscripts k, m, n and p are preferably numbers satisfying 0<k≦1, especially 0.001≦k ≦0.8, 0<m≦3, especially 0.5≦m≦2.3, 0≦n≦1, especially 0≦n≦0.5, 0≦p≦3, especially 0≦p≦1.5, and 1≦k+m+n+p<4, especially 1.5≦k+m+n+p≦2.7. The position of silicon-bonded hydrogen atom is not critical and may be at an end or midway of the molecule.

Examples of the organohydrogenpolysiloxane include, but are not limited to, end-capped organo (e.g., methyl)hydrogenpolysiloxanes such as trimethylsilyl- or tripphenylsilyl-end-capped organo(e.g., methyl)hydrogen-polysiloxanes and dimethylhydrogensilyl-end-capped organo(e.g., methyl)hydrogenpolysiloxanes as well as tetramethyltetrahydrogencyclotetrasiloxane, pentamethyltrihydrogencyclotetrasiloxane, and tri(dimethylhydrogensiloxane)methylsilane.

Also useful is a compound of the following structure.

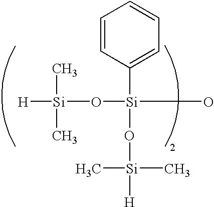

The molecular structure of the organohydrogenpolysiloxane may be either straight, branched, cyclic or network. The organohydrogenpolysiloxane can be obtained by hydrolysis of a chlorosilane such as R⁴SiHCl₂, (R⁴)₃SiCl, (R⁴)₂SiCl₂, or (R⁴)₂SiHCl wherein R⁴ is as defined above, or by hydrolysis of a dimer or oligomer of alkoxysilane or dihydrogentetramethyldisiloxane such as HSi(OR⁵)₃, R⁴Si(OR⁵)₃, R⁴SiH(OR⁵)₂, (R⁴)₂Si(OR⁵)₂, (R⁴)₃Si(OR⁵), or (R⁴)₂SiH(OR⁵) wherein R⁴ and R⁵ are as defined above.

The organohydrogenpolysiloxane (D) is compounded in an effective amount to induce curing of component (A′), that is, hydrosilylation reaction of groups containing a multiple bond capable of participating in hydrosilylation reaction. Preferably component (D) is used in such amounts that the molar ratio of SiH groups to groups containing a multiple bond capable of participating in hydrosilylation reaction in component (A′), specifically aliphatically unsaturated groups such as vinyl groups is from 0.1 to 4.0, more preferably from 0.5 to 3.0, and even more preferably from 0.8 to 2.4. A molar ratio of less than 0.1 may allow curing reaction to proceed little and make it difficult to produce cured parts. At a molar ratio in excess of 4.0, a substantial amount of unreacted SiH groups may be left in the cured composition which will change its physical properties with the passage of time. Where component (D) is added to the embodiment using component (AD), the molar ratio of SiH groups in components (AD) and (D) to groups containing a multiple bond capable of participating in hydrosilylation reaction in component (AD) may be adjusted to the above range.

Component E

Component (E) is a platinum group metal-based catalyst which is compounded for inducing addition cure reaction to the inventive composition. Platinum, palladium and rhodium base catalysts are included. Of these, platinum base catalysts are preferred from the economical standpoint. Specific examples include H₂PtCl₆.xH₂O, K₂PtCl₆, KHPtCl₆.xH₂O, K₂PtCl₄, K₂PtCl₄.xH₂O, PtO₂.xH₂O, PtCl₄.xH₂O, PtCl₂, and H₂PtCl₄.xH₂O wherein x is a positive integer, and complexes thereof with hydrocarbons, alcohols and vinyl-containing organopolysiloxanes. They may be used alone or in admixture. The catalyst (E) may be used in a catalytic amount, specifically in an amount to give about 0.1 to 1,000 ppm, preferably 1 to 300 ppm of platinum group metal based on the weight of components (A′), (B) and (D) combined or the weight of components (AD) and (B) combined.

In the epoxy/silicone hybrid resin composition of the invention, at least one of components (A) and (B), at least one of components (A′), (B) and (D) if component (A′) is used, or at least one of components (AD) and (B) if component (AD) is used should be solid at normal temperature. When the remaining component(s) other than the solid component is liquid, it should preferably have a viscosity of at least 100 Pa·s at normal temperature as measured by a rotational viscometer of BM type (the same applies throughout the disclosure). Particularly in the embodiment using component (A′), it is preferred that this organosilicon compound (A′) be solid or liquid with a viscosity of at least 100 Pa·s, the epoxy resin (B) be solid or liquid with a viscosity of at least 100 Pa·s, and at least one of components (A′) and (B) be solid, all determined at normal temperature.

The epoxy/silicone hybrid resin composition of the invention is solid at normal temperature. In order that the composition be solid, the proportion of solid component(s) in the entire organic resins (i.e., total of components (A) and (B) or components (A), (B) and (D)) should preferably be at least 30% by weight (generally 30 to 100% by weight), more preferably 40 to 100% by weight.

Component F

In the epoxy/silicone hybrid resin composition of the invention, (F) an adhesive aid may be optionally added for improving the adhesion of the cured composition as long as the objects of the invention are not impaired, that is, the composition remains solid at normal temperature. Suitable adhesive aids are organosilicon compounds having silicon-bonded alkoxy groups such as organosilanes and organopolysiloxanes. Examples of suitable organosilicon compounds include alkoxysilanes such as tetramethoxysilane, tetraethoxysilane, dimethyldimethoxysilane, methylphenyldimethoxysilane, methylphenyldiethoxysilane, phenyltrimethoxysilane, methyltrimethoxysilane, methyltriethoxysilane, vinyltrimethoxysilane, allyltrimethoxysilane, allyltriethoxysilane, 3-glycidoxypropyltrimethoxysilane, and 3-methacryloxypropyltrimethoxysilane as well as siloxane compounds of straight chain or cyclic structure (i.e., organosiloxane oligomers) having about 4 to about 30 silicon atoms, especially about 4 to about 20 silicon atoms, and containing per molecule at least two, preferably two or three, functional groups selected from among silicon-bonded hydrogen atoms (SiH groups), silicon-bonded alkenyl groups (e.g., Si—CH═CH₂), alkoxysilyl groups (e.g., trialkoxysilyl groups such as trimethoxysilyl), epoxy groups (e.g., glycidoxypropyl and 3,4-epoxycyclohexylethyl), and preferably free of a silanol group.

In a preferred embodiment, organoxysilyl-modified isocyanurate compounds having the general formula (4) and/or hydrolytic condensates thereof (i.e., organosiloxane-modified isocyanurate compounds) are used as the adhesive aid (F). 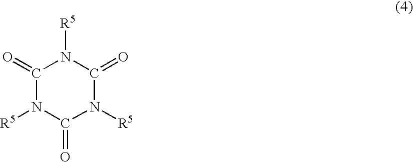
Herein Rs is an organic group having the formula (5): 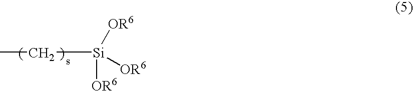
(wherein R⁶ is hydrogen or a monovalent hydrocarbon group of 1 to 6 carbon atoms, and s is an integer of 1 to 6, especially 1 to 4) or a monovalent hydrocarbon group containing an aliphatically unsaturated bond, and at least one of three Rs is an organic group of formula (5).

Examples of the monovalent hydrocarbon group containing aliphatic unsaturation, represented by R⁵, include alkenyl groups of 2 to 8 carbon atoms, especially 2 to 6 carbon atoms, such as vinyl, allyl, propenyl, isopropenyl, butenyl, isobutenyl, pentenyl, hexenyl, and cyclohexenyl. The monovalent hydrocarbon groups represented by R⁶ include those of 1 to 8 carbon atoms, preferably 1 to 6 carbon atoms, for example, alkyl groups such as methyl, ethyl, propyl, isopropyl, butyl, isobutyl, tert-butyl, pentyl, hexyl and cyclohexyl, alkenyl groups such as vinyl, allyl, propenyl and isopropenyl, and aryl groups such as phenyl. Of these, alkyl groups are preferred.

Illustrative examples of the adhesive aid are given below. 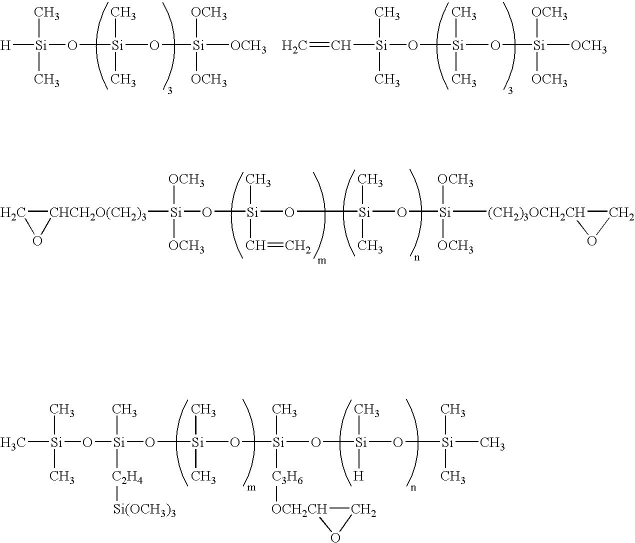
(Subscripts m and n are positive integers satisfying m+n=2 to 50, preferably 4 to 20.)

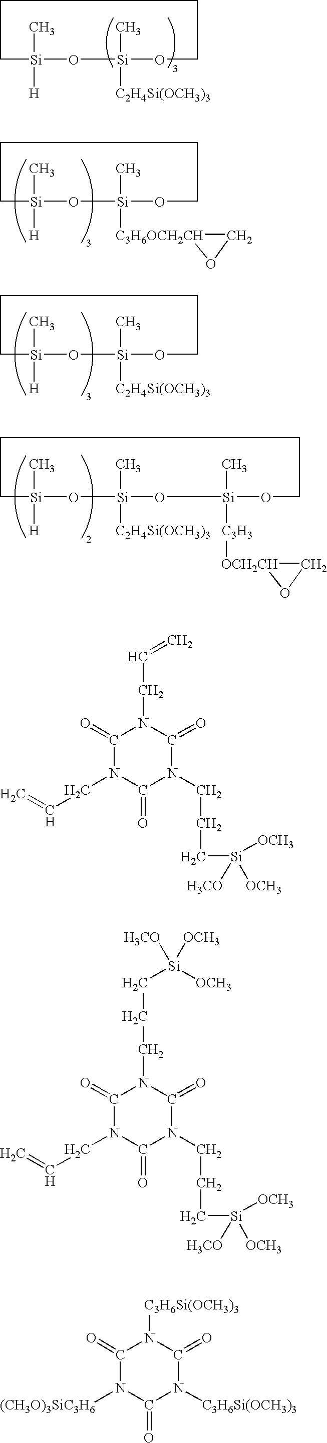

Of the organosilicon compounds, those organosilicon compounds having silicon-bonded alkoxy groups and silicon-bonded alkenyl groups or silicon-bonded hydrogen atoms (i.e., SiH groups) in a molecule are preferred because the cured compositions become more adhesive.

The adhesive aid, which is optional, may be included in an amount of up to about 10 parts by weight (i.e., 0 to 10 parts by weight), preferably about 0.01 to 5 parts by weight, more preferably about 0.1 to 1 part by weight, per 100 parts by weight of components (A) or (A′) or (AD) and (B) combined. Too less amounts of the adhesive aid may fail to achieve the desired effect whereas too much amounts may be detrimental to compositions which should be solid at normal temperature, or adversely affect the hardness and surface tack of a cured composition.

The epoxy/silicone hybrid resin composition can be prepared by combining components (A), (B) and (C), or components (A′), (B), (C), (D) and (E), or components (AD), (B), (C) and (E), and optional components including (F) and the like, and heat or melt mixing and/or grinding into fine powder and mechanical mixing. When a composition comprising components (A′), (B), (C), (D) and (E), or components (AD), (B), (C) and (E) is prepared by mixing, it is preferable to add minor amounts of reaction inhibitors such as acetylene alcohol compounds, nitrogen compounds (e.g., triazoles, nitrile compounds) or phosphorus compounds to the composition for extending the pot-life.

In the epoxy/silicone hybrid resin composition, various additives may be incorporated as long as the objects of the invention are not compromised, that is, the composition remains solid at normal temperature. Suitable additives include antioxidants such as BHT and vitamin B, well-known anti-discoloring agents such as organophosphorus anti-discoloring agents, anti-photo-degrading agents such as hindered amines, epoxy crosslinking agents such as acid anhydrides, compatibilizing agents such as low-molecular-weight silicon compounds, liquid vinylsiloxanes, hydrogensiloxanes and epoxy compounds, reactive diluents such as minute amounts of vinyl ethers, vinyl amides, epoxy resins other than component (B), oxetanes, allyl phthalates, and vinyl adipate, reinforcing fillers such as glass fibers, fumed silica, precipitated silica, and other inorganic or organic ultra-microparticulates, and flame retardance improvers. Also the composition may be colored with colorants.

It is understood that the epoxy/silicone hybrid resin composition comprising components (A′), (B), (C), (D) and (E) or components (AD), (B), (C) and (E) as essential components and adapted to cure through condensation of epoxy resin in combination with hydrosilylation or addition reaction is desirable over the epoxy/silicone hybrid resin composition comprising components (A), (B) and (C) and adapted to cure solely through condensation of epoxy resin because the former is more reliable.

The epoxy/silicone hybrid resin composition of the invention is suited as encapsulating (embedding and protecting) material for optical and other semiconductor members, and adhesives such as die attaching agents. Cured parts of the composition can also be used as substrates such as package blanks and printed board blanks, and lens.

For the inventive composition, the curing conditions may be selected from a wide range from the melting point of resin (about 50° C.) to 200° C. and in accordance with working conditions. An appropriate set of conditions may be determined by taking a balance with productivity and cured properties. In the event of transfer molding or compression molding, the cured product is obtained by molding at a temperature of 100 to 180° C. for a time of several tens of seconds to 5 minutes.

### EXAMPLE

Examples of the invention are given below by way of illustration and not by way of limitation. All parts are by weight. Me is methyl, Vi is vinyl, Ph is phenyl, and Gp is glycidoxypropyl. The term “normally solid” means that the indicated material is solid at normal temperature.

### Example 1

An epoxy/silicone hybrid resin composition was prepared by melt mixing 70 parts of a normally solid organopolysiloxane of the composition (ViMeSiO)_{0.2}(PhSiO_{3/2})_{0.7}(MeSiO_{3/2})_{0.1} and containing 5 wt % of silicon-bonded hydroxyl groups with 30 parts of a hydrogenated bisphenol A epoxy resin YL7031 (Japan Epoxy Resin Co., Ltd.). To the mixture, an organohydrogenpolysiloxane of the formula: (HMeSiO)_{0.2}(PhSiO_{3/2})_{0.4}(Me₂SiO)_{0.4} was added in such an amount that silicon-bonded hydrogen atoms (h) in the organohydrogenpolysiloxane and vinyl groups (v) in the organopolysiloxane were at a molar ratio (h/v) of 1.1/1. Also, catalytic amounts of platinum catalyst and aluminum acetylacetone were added. The mixture was thoroughly mixed at 60° C. and then cooled to 5° C. The resulting solid was ground, obtaining the epoxy/silicone hybrid resin composition in powder form. The powder was a tack-free solid at room temperature.

Next, the powder was worked into tablets. Using a transfer molding machine, bars were molded. The molded bars were heated at 150° C. for 4 hours until the resin was completely cured. The cured part was colorless and transparent. The light transmittance of the cured part was measured before and after heating at 100° C. for 1,000 hours. A retention of transmittance calculated from the initial and final transmittances was higher than 90%, indicating high transparency.

### Example 2

An epoxy/silicone hybrid resin composition was prepared by melt mixing 70 parts of a highly viscous organopolysiloxane of the composition (ViMeSiO)_{0.3}(PhSiO_{3/2})_{0.6}(Me₂SiO)_{0.1} and containing 4 wt % of silicon-bonded hydroxyl groups with 30 parts of a normally solid hydrogenated bisphenol A epoxy resin YL7170 (Japan Epoxy Resin Co., Ltd.). To the mixture, an organohydrogenpolysiloxane of the formula: (HMeSiO)_{0.2}(PhSi_{3/2})_{0.4}(Me₂SiO)_{0.4} was added in such an amount that silicon-bonded hydrogen atoms (h) in the organohydrogenpolysiloxane and vinyl groups (v) in the organopolysiloxane were at a molar ratio (h/v) of 1.1/1. Also, catalytic amounts of platinum catalyst and aluminum acetylacetone were added. The mixture was thoroughly mixed at 60° C. and then cooled to 5° C. The resulting solid was ground, obtaining the epoxy/silicone hybrid resin composition in powder form. The powder was a tack-free solid at room temperature.

Next, the powder was worked into tablets. Using a transfer molding machine, bars were molded. The molded bars were heated at 150° C. for 4 hours until the resin was completely cured. The cured part was colorless and transparent. The light transmittance of the cured part was measured before and after heating at 100° C. for 1,000 hours. A retention of transmittance calculated from the initial and final transmittances was higher than 90%, indicating high transparency.

### Example 3

An epoxy/silicone hybrid resin composition was prepared by melt mixing 70 parts of a highly viscous organopolysiloxane of the composition (ViMeSiO)_{0.3}(PhSiO_{3/2})_{0.6}(Me₂SiO)_{0.1} and containing 4 wt % of silicon-bonded hydroxyl groups with 30 parts of a normally solid alicyclic epoxy resin EHPE3150 (Daicel Chemical Industries, Ltd.). To the mixture, an organohydrogenpolysiloxane of the formula: (HMeSiO)_{0.2}(PhSiO_{3/2})_{0.4}(Me₂SiO)_{0.4} was added in such an amount that silicon-bonded hydrogen atoms (h) in the organohydrogenpolysiloxane and vinyl groups (v) in the organopolysiloxane were at a molar ratio (h/v) of 1.1/1. Also, catalytic amounts of platinum catalyst and aluminum acetylacetone were added. The mixture was thoroughly mixed at 60° C. and then cooled to 5° C. The resulting solid was ground, obtaining the epoxy/silicone hybrid resin composition in powder form. The powder was a tack-free solid at room temperature.

Next, the powder was worked into tablets. Using a transfer molding machine, bars were molded. The molded bars were heated at 150° C. for 4 hours until the resin was completely cured. The cured part was colorless and transparent. The light transmittance of the cured part was measured before and after heating at 100° C. for 1,000 hours. A retention of transmittance calculated from the initial and final transmittances was higher than 90%, indicating high transparency.

### Example 4

An epoxy/silicone hybrid resin composition was prepared by melt mixing 70 parts of a highly viscous organopolysiloxane of the composition (ViMeSiO)_{0.2}(HMeSiO)_{0.2}(PhSiO_{3/2})_{0.6} and containing 4 wt % of silicon-bonded hydroxyl groups with 30 parts of a normally solid alicyclic epoxy resin EHPE3150 (Daicel Chemical Industries, Ltd.). To the mixture, catalytic amounts of platinum catalyst and aluminum acetylacetone were added. The mixture was thoroughly mixed at 60° C. and then cooled to 5° C. The resulting solid was ground, obtaining the epoxy/silicone hybrid resin composition in powder form. The powder was a tack-free solid at room temperature.

Next, the powder was worked into tablets. Using a transfer molding machine, bars were molded. The molded bars were heated at 150° C. for 4 hours until the resin was completely cured. The cured part was colorless and transparent. The light transmittance of the cured part was measured before and after heating at 100° C. for 1,000 hours. A retention of transmittance calculated from the initial and final transmittances was higher than 90%, indicating high transparency.

### Example 5

An epoxy/silicone hybrid resin composition was prepared by mixing 70 parts of a normally solid organopolysiloxane of the composition (GpSiO_{3/2})_{0.4} (PhSiO_{3/2})_{0.6} and containing 5 wt % of silicon-bonded hydroxyl groups with 30 parts of a normally solid hydrogenated bisphenol A epoxy resin YL7170 (Japan Epoxy Resin Co., Ltd.) and a catalytic amount of aluminum acetylacetone, in fine powder form. The resulting powder was a tack-free solid at room temperature.

Next, the powder was worked into tablets. Using a transfer molding machine, bars were molded. The molded bars were heated at 150° C. for 4 hours until the resin was completely cured. The cured part was colorless and transparent. The light transmittance of the cured part was measured before and after heating at 100° C. for 1,000 hours. A retention of transmittance calculated from the initial and final transmittances was higher than 90%, indicating high transparency.

### Comparative Example 1

A resin composition was prepared by melt mixing 70 parts of a highly viscous organopolysiloxane of the composition (ViMeSiO)_{0.3}(PhSiO_{3/2})_{0.6}(Me₂SiO)_{0.1} and containing 4 wt % of silicon-bonded hydroxyl groups with 30 parts of hydrogenated bisphenol A epoxy resin YL7031 (Japan Epoxy Resin Co., Ltd.). To the mixture, an organohydrogenpolysiloxane of the formula: (HMeSiO)_{0.2}(PhSiO_{3/2})_{0.4}(Me₂SiO)_{0.4} was added in such an amount that silicon-bonded hydrogen atoms (h) in the organohydrogenpolysiloxane and vinyl groups (v) in the organopolysiloxane were at a molar ratio (h/v) of 1.1/1. Also, catalytic amounts of platinum catalyst and aluminum acetylacetone were added. The mixture was thoroughly mixed at 60° C. and then cooled to 5° C. The cooled mixture was so tacky at normal temperature that it could not be ground into powder.

Japanese Patent Application No. 2005-364415 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. An epoxy/silicone hybrid resin composition comprising
(A) an organosilicon compound having at least one silicon-bonded hydroxyl group per molecule,
(B) an epoxy resin free of a phenylene ether skeleton, and
(C) an aluminum base curing catalyst, at least one of components (A) and (B) being solid at normal temperature, and said composition being solid at normal temperature.

2. An epoxy/silicone hybrid resin composition comprising
(A′) an organosilicon compound having at least one group containing a multiple bond capable of participating in hydrosilylation reaction and at least one silicon-bonded hydroxyl group per molecule,
(B) an epoxy resin free of a phenylene ether skeleton,
(C) an aluminum base curing catalyst,
(D) an organohydrogenpolysiloxane, and
(E) a platinum group metal-based catalyst, at least one of components (A′), (B) and (D) being solid at normal temperature, and said composition being solid at normal temperature.

3. The epoxy/silicone hybrid resin composition of claim 2, wherein at normal temperature, the organosilicon compound (A′) is solid or liquid with a viscosity of at least 100 Pa·s, the epoxy resin (B) is solid or liquid with a viscosity of at least 100 Pa·s, and at least one of components (A′) and (B) is solid.

4. An epoxy/silicone hybrid resin composition comprising
(AD) an organosilicon compound having at least one group containing a multiple bond capable of participating in hydrosilylation reaction, at least one silicon-bonded hydrogen atom, and at least one silicon-bonded hydroxyl group per molecule,
(B) an epoxy resin free of a phenylene ether skeleton,
(C) an aluminum base curing catalyst, and
(E) a platinum group metal-based catalyst, at least one of components (AD) and (B) being solid at normal temperature, and said composition being solid at normal temperature.

5. The epoxy/silicone hybrid resin composition of claim 1, for cast molding.

6. A cured part obtained by cast molding the epoxy/silicone hybrid resin composition of claim 1.
